(19) United States
(12) Patent Application Publication
(10) Pub. No.: US 2026/0103325 A1
(43) Pub. Date: Apr. 16, 2026

(54) SEALING SYSTEM FOR REDUCING OXYGEN CONTENT WITHIN A CONTAINER

(71) Applicant: Chang Chyan Liow, Windsor, CA (US)

(72) Inventor: Chang Chyan Liow, Windsor, CA (US)

(21) Appl. No.: 19/409,825

(22) Filed: Dec. 5, 2025

Related U.S. Application Data
(63) Continuation-in-part of application No. 18/525,037, filed on Nov. 30, 2023.

(51) Int. Cl. B65D 81/26; B65D 81/20

(52) U.S. Cl. CPC B65D 81/266; B65D 81/2038; B65D 81/2076; B65D 2205/02

(57) ABSTRACT

A sealing system for a container to provide a combined protection of inert gas and oxygen scavenger methods. The sealing system comprises a closure unit and a backfill unit. The closure unit is inserted into an open end of the container. The closure unit comprises a hollow chamber, a lid, and a sealing member. The closure unit is removably coupled to the open end of the container through at least one of a friction fit, a snap fit, a rotatable fit or screw fit, or any of a variety of fastening mechanisms. The backfill unit is configured to be attached to the one-way valve of the lid. The backfill unit is configured to create a vacuum-conditioned environment in the headspace of the container. The sealing system provides a combined protection of inert gas and oxygen scavenger methods. The sealing system combines inert-gas infusion and oxygen-scavenging to reduce oxidation and preserve product quality.

### FIELD OF INVENTION

The present disclosure relates generally to container sealing systems, and more particularly to a sealing system designed to reduce or eliminate oxygen content within a sealed container through vacuum-assisted deoxygenation and inert gas infusion to preserve the quality and shelf life of oxygen-sensitive products.

### BACKGROUND

Oxidation adversely affects oxygen-sensitive products such as food, beverages, pharmaceuticals, and chemicals. Oxygen exposure triggers undesirable chemical reactions, microbial growth, and flavor or color degradation, ultimately reducing product quality and shelf life. For instance, studies have demonstrated that aromatic compounds such as 3-mercaptohexanol, which impart fruity and tropical aromas to Sauvignon blanc wines, degrade rapidly when wines are stored in oxygen-rich environments.

Exposure of the oxygen-sensitive products to atmospheric conditions leads to oxidative degradation, resulting in loss of effectiveness and the development of unpleasant or altered sensory characteristics. For example, once a bottle of aromatic alcoholic beverages such as wine, gin, or sake is opened, exposure to atmospheric oxygen rapidly initiates oxidation and microbial activity. This exposure shortens the shelf life of the beverage and results in undesirable changes in taste, aroma, and appearance. In particular, wine loses its characteristic freshness and flavor balance as oxygen triggers chemical reactions and promotes bacterial growth, ultimately leading to quality degradation.

Conventional preservation approaches for oxygen-sensitive substances include the use of corks or stoppers, vacuum sealing, and inert-gas displacement. Commercially available solutions for preserving opened wine bottles generally fall into two categories such as vacuum preservation and inert gas or “air-displacement” methods. Each of these techniques has inherent limitations that restrict their effectiveness.

Vacuum preservation methods operate by partially removing air, including oxygen, from a container to inhibit oxidative degradation and extend the shelf life of oxygen-sensitive products such as wine, fresh fruits, and vegetables. This process creates a partial vacuum within the container, which slows down chemical and microbial spoilage. However, excessive vacuum pressure can alter the taste, texture, or aroma of certain products, particularly those containing volatile compounds. Existing vacuum preservation systems include hand-operated vacuum sealers and industrial-grade vacuum packaging machines commonly used in food processing and storage applications.

Hand-operated vacuum sealers are significantly less powerful than industrial vacuum systems and therefore can only generate a limited partial vacuum. Although they remove a portion of the air from a container, residual oxygen remains, which restricts the shelf life of stored products to only a few days. In addition, the vacuum process can extract volatile aromatic compounds from the contents, adversely affecting their taste and aroma. Consequently, hand-operated vacuum sealers are unsuitable for preserving products with strong or delicate flavor profiles, such as coffee, spices, or wine.

Industrial vacuum sealers are capable of generating a strong vacuum and can substantially extend the shelf life of packaged food products. However, these systems are expensive, complex to operate, and unsuitable for certain types of products. Excessive vacuum pressure can alter the taste, texture, or structural integrity of delicate foods. For instance, vacuum sealing fresh fruits and vegetables that release ethylene gas can accelerate ripening and reduce freshness. In contrast, air-displacement or inert gas preservation methods replace the air in the container headspace with an inert gas to prevent oxidation. Although this approach is generally more effective than simple vacuum preservation, it requires specialized equipment and gas cartridges, making it costlier and less convenient for routine use.

Oxygen scavengers are commonly used to chemically remove residual oxygen from containers, such as wine bottles, to reduce oxidation. These materials react with oxygen upon exposure to air and are effective in lowering oxygen concentration over time. However, oxidation-sensitive substances like wine remain susceptible to degradation during the initial activation period of the scavenger. The reaction kinetics of oxygen scavengers depend on their chemical composition and ambient conditions, often requiring between 8 and 72 hours to achieve full oxygen removal. During this delay, residual oxygen in the headspace continues to promote oxidative reactions, leading to gradual deterioration in the quality and flavor of the product.

Although oxygen scavengers initiate their reaction with oxygen immediately, they can generate undesirable side effects within the container. Ferrous-based scavengers, commonly formulated with iron powder, provide rapid oxygen removal but often impart metallic or “rusty” aromas and flavors, rendering the wine reductive and altering its intended sensory profile. Furthermore, as the scavenger absorbs oxygen, the resulting negative pressure within the container can strip volatile aromatic compounds from the wine, diminishing its bouquet and overall quality.

Both vacuum preservation and inert gas displacement methods can extend the shelf life of opened wine; however, each presents inherent limitations. Vacuum preservation often alters the taste and aromatic profile of the wine by removing volatile compounds, while inert gas displacement systems are costly, require specialized equipment, and are inconvenient for routine use. Existing preservation approaches for food, beverages, and other oxygen-sensitive liquids remain expensive, cumbersome, and only partially effective. They frequently fail to maintain the product's intended flavor characteristics, are difficult to clean, and pose risks of cross-contamination when reused. Moreover, conventional closure devices do not provide a combined mechanism that integrates inert gas protection with oxygen-scavenging capability to ensure comprehensive and long-term oxidation control.

Several prior art references attempt to address these issues but remain technically inadequate. For example, a prior art, U.S. Pat. No. 11,760,546B2 describes a de-oxygenation stopper that is designed to minimize oxygen content in a vessel, allowing wine and other oxygen-sensitive materials to age properly. It has an oxygen scavenging element that removes oxygen molecules and a sealing element that controls oxygen transmission at a desired rate. This can be helpful for preserving foods and beverages that are sensitive to oxygen, such as wine and olive oil. However, the de-oxygenation stopper is not suitable for all types of containers. For example, it cannot be used with containers that have a very narrow neck or that are made of a material that is not compatible with the stopper. In addition, the de-oxygenation stopper controls the oxygen transmission at a desired rate and does not provide a protective layer over the oxidation-sensitive substances. This means any remaining oxygen can still oxidize and degrade the food or beverage. This method often has ferrous oxygen scavengers, commonly known as iron powder, offer rapid oxygen removal but can impart undesirable metallic or “rusty” aromas and flavors, rendering the wine “reductive”. Additionally, the oxygen scavengers also remove volatile aromas of the wine due to negative pressure caused by the absorption of oxygen.

In another prior art US20150069085A1 describes devices and methods for extracting fluids from containers sealed with corks or septums. The devices are used to extract and preserve a fluid such as wine stored in a container. The devices could be fixed to the container and injects compressed air or other gases into the container for extracting the fluid from the container. The compressed air or other gas may act directly or indirectly on the wine in the container. However, the devices are expensive and can displace vital volatile aromatics of the wine when the inert gases are injected into the container. In addition, holes on a cork created by a needle of the apparatus during installation can cause wine leaks and may allow the oxygen to enter into the container. Further, there's a risk of bottle explosion due to excessive internal pressure. Moreover, the needle and wine displacement may cross-contaminate between multiple bottles if not properly sanitized after each use. Therefore, employing the apparatus to preserve the fluids like wine in the containers is not deemed a reliable or effective method.

In another prior art US20190270560A1 describe systems and methods that utilize an oxygen scavenging agent coupled to a sealing device to remove oxygen from the headspace of a container, effectively preserving oxidizable substances like liquids or foodstuffs. The oxygen scavenging agent removes the oxygen without significantly reducing the pressure in the headspace, preventing adverse effects on the flavor of the substance, such as wine. However, the described systems and methods only use oxygen scavenging agent to remove oxygen and does not provide any protective layer over the oxidation-sensitive substances. This means any remaining oxygen can still oxidize and degrade the food or beverage. Further, the device is bulky, which can make it difficult to store and use. This method often has ferrous oxygen scavengers, commonly known as iron powder, offer rapid oxygen removal but can impart undesirable metallic or “rusty” aromas and flavors, rendering the wine “reductive”. Additionally, the oxygen scavengers also remove volatile aromas of the wine due to negative pressure caused by the absorption of oxygen.

In another prior art U.S. Pat. No. 4,473,174A discloses a device for preserving and dispensing wine from a bottle. The device includes a stopper assembly that is inserted into the neck of the bottle and a removable cap assembly. The cap contains a chamber that houses a pressurized gas cartridge. The stopper assembly has a valve with three positions: off, vent, and pressurize. In the pressurize position, gas from the cartridge is released into the bottle to create an inert atmosphere. In the vent position, excess pressure in the bottle can be released. A second valve in the stopper assembly controls a spout from which wine is dispensed. However, the device is expensive, complex, and not suitable for all products as it can alter the taste and texture of some foods.

Researchers have conducted several studies on beverage packaging using different materials. One study focused on orange juice packaging and found that orange juice stored in monolayer PET bottles with an oxygen scavenger, liquid nitrogen in the headspace, and an aluminum foil seal in the screw-cap had a shelf life of nine months at 4° C. and nearly eight months at 25° C. This study also indicated that the color stability and shelf life of orange juice could be extended by lowering the storage temperature and preventing oxygen permeation through the packaging.

Therefore, there is a need for a sealing system that provides comprehensive and dual-stage protection for preserving oxygen-sensitive substances such as wines, beverages, and food products. There is also a need for a sealing system that establishes a protective inert gas barrier to prevent further oxidation in the container headspace. There is also a need for a sealing system that overcomes the drawbacks of existing preservation methods by combining the chemical absorption capability of oxygen scavengers with the physical displacement and sealing properties of inert gases under controlled vacuum conditions. There is also a need for a sealing system that operates efficiently without introducing undesirable odors, metallic off-flavors, or reductive characteristics commonly associated with ferrous-based scavengers. There is also a need for a sealing system that maintains a substantially airtight seal to prevent re-entry of ambient air once the container is resealed, ensuring long-term stability and preservation of the product's original flavor, aroma, and quality. Further, there is also a need for a compact, easy-to-use, and cost-effective sealing system that is specifically engineered for narrow-necked vessels such as wine bottles, providing reliable protection in both domestic and commercial applications.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to a sealing system for reducing oxygen content within a container. The sealing system comprises a closure unit and a backfill unit.

In one embodiment, the closure unit is adapted to be inserted into an open end of the container. The closure unit comprises a hollow chamber, a lid, and a sealing member. The closure unit is removably coupled to the open end of the container through at least one of a friction fit, a snap fit, a rotatable fit or screw fit, or any of a variety of fastening mechanisms.

In one embodiment, the hollow chamber is configured to hold at least one absorbent material. The hollow chamber is adapted to expose the absorbent material to a headspace of the container for absorbing oxygen. The lid is coupled to the hollow chamber. The lid includes a one-way valve configured to permit air present in the headspace of the container to exit the container while preventing ingress of external air.

In one embodiment, the hollow chamber comprises at least one of a mesh, perforated casing, and semi-porous polymer shell configured to expose the absorbent material for absorbing oxygen from the headspace of the container. The lid is configured to provide access to the hollow chamber for insertion of the absorbent material inside the closure unit. The absorbent material is a de-oxygenation agent or an oxygen scavenging agent. The absorbent material includes at least one of a metal-based compound, a ferrous-based scavenger, and a non-ferrous absorbent material.

The sealing member is disposed circumferentially extended around an outer surface of the hollow chamber. The sealing member is configured to form an airtight connection with the open end of the container during operation. The sealing member comprises at least one of a silicone, and elastomeric material configured to deform and conform to differently sized open ends of the container.

In one embodiment, the backfill unit is configured to be attached to the one-way valve of the lid. The backfill unit is configured to evacuate internal air present in the headspace of the container through the one-way valve of the lid located on the container. The backfill unit is automatically controlled by a controller to regulate vacuum pressure and gas-release timing. The backfill unit comprises a body, a vacuum pump, and a gas reservoir.

In one embodiment, the body having an inlet configured for attachment to the one-way valve, and an outlet configured for releasing extracted air. The vacuum pump could be secured within the body and coupled to the inlet. The vacuum pump is configured to remove at least a portion of the internal air present in the headspace of the container, thereby reducing internal pressure in the headspace of the container. The internal air comprises, primarily containing oxygen and nitrogen. The internal air may additionally include other oxygen-containing gases.

In one embodiment, the gas reservoir is disposed within the body. The gas reservoir is configured to contain one or more inert gases. The inert gases are released into the container through the inlet following at least partial extraction of the internal air, thereby forming a protective barrier against oxidation within the container. The released inert gases and the absorbent material exposed in the headspace collectively establish the protective barrier against oxidation within the container. The inert gases include at least one or a mixture of gases that are heavier than oxygen, which include at least one of argon gas, krypton gas, xenon gas, and carbon dioxide gas.

In one embodiment, the backfill unit comprises a power source configured to operate the vacuum pump. The backfill unit comprises a user interface that includes an on/off switch and at least one indicator for vacuum level or gas dispensing status.

The inlet of the backfill unit maintains the one-way valve open during the vacuum phase, and once the desired vacuum pressure is achieved, the backfill unit then releases the appropriate amount of the inert gases into the container through the one-way valve. After releasing the inert gas, the backfill unit disengages, allowing the one-way valve to close automatically due to the pressure differential between the container and the surrounding environment. The lid remains securely attached to the container, thereby ensuring an airtight connection during the entire process.

In one embodiment herein, a method for reducing oxygen content within the container using the sealing system is disclosed. At one step, the closure unit is inserted unit into the open end of the container. At another step, the closure unit is sealed against the open end of the container by deforming the sealing member to form an airtight connection that prevents ingress of external air. At another step, at least one absorbent material is positioned within the hollow chamber of the closure unit. The absorbent material is a de-oxygenation or oxygen-scavenging agent adapted to absorb oxygen from a headspace of the container.

At another step, the backfill unit is attached to the one-way valve on the lid. The backfill unit is automatically controlled by the controller to regulate the vacuum pressure, keeping the one-way valve open during the oxygen evacuation. After the vacuum pressure is achieved, the backfill unit releases inert gases into the container. The lid remains securely attached, and the sealing member maintains an airtight connection throughout the process. At another step, the vacuum pump is activated to evacuate the internal air present in the headspace of the container through the one-way valve, thereby reducing internal pressure within the container.

At another step, the one or more inert gases are dispensed from the gas reservoir through the one-way valve into the container following at least partial extraction of the internal air. The inert gases form the protective barrier above the contents of the container to inhibit oxidation. At another step, the closure unit is maintained in a sealed position after detaching the backfill unit, thereby preventing re-entry of external air into the container. Further, at another step, the absorbent material absorbs the residual oxygen molecules remaining within the headspace of the container to further reduce the oxygen concentration inside the container.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a perspective view of a sealing system for a container, in accordance with embodiments of the invention.

FIG. 2 illustrates a perspective view of a closure unit of the sealing system, in accordance with embodiments of the invention.

FIG. 3 illustrates a illustrates a flowchart of a method for reducing oxygen content within the container using the sealing system, in accordance with embodiments of the invention.

FIG. 4 illustrates a perspective view of a backfill unit of the sealing system, in accordance with embodiments of the invention.

FIG. 5 illustrates an angled internal view of the backfill unit of the sealing system, in accordance with embodiments of the invention.

FIG. 6 illustrates a perspective view of a vacuum pump of the backfill unit, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

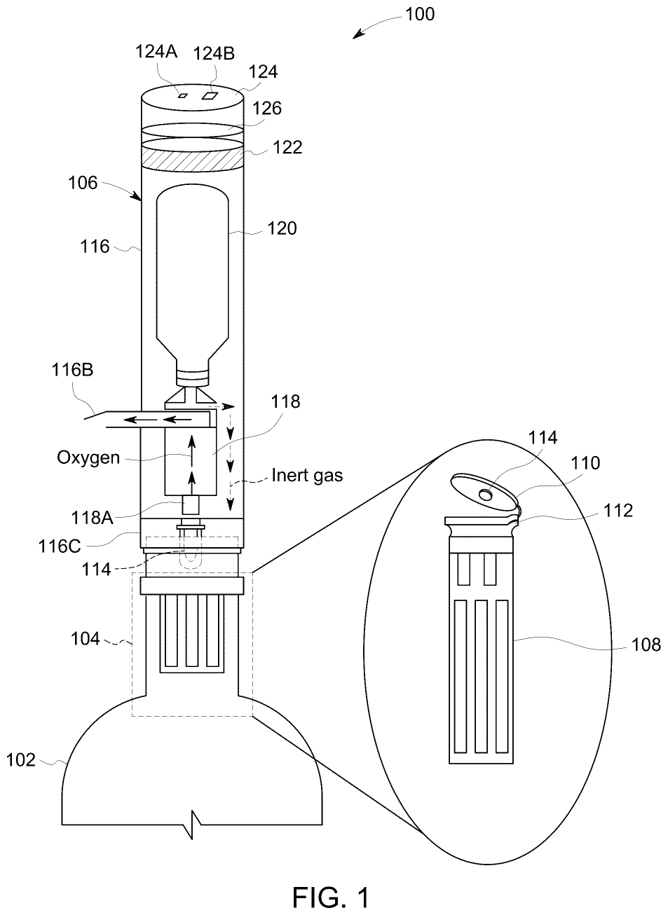

FIG. 1 illustrates a perspective view of a sealing system 100 configured for use with a container 102. In one embodiment, the sealing system 100 is designed to reduce the oxygen content within a container 102 by providing a combined protection mechanism that integrates inert gas purging and oxygen scavenging techniques. In one embodiment, the sealing system 100 comprises a closure unit 104 and a backfill unit 106, which cooperatively function to establish and maintain a controlled, low-oxygen environment inside the container 102.

In one embodiment, the container 102 includes, but is not limited to, wine bottles, reusable food storage containers, and other vessels. In another embodiment, the closure unit 104 described herein can be applied to any oxygen-sensitive substance for which preservation or storage is desired. For example, wine, foodstuffs, other liquids, pharmaceuticals or drugs, chemicals, paints, adhesives, or any of a variety of materials can be contemplated.

In one embodiment, the closure unit 104 is adapted to be inserted into an open end of the container 102. The closure unit 104 comprises a hollow chamber 108, a lid 110, and a sealing member 112. In one embodiment, the closure unit 104 is removably coupled to the open end of the container 102 through at least one of, but not limited to, a friction fit, a snap fit, a rotatable fit, a screw fit, and any of a variety of fastening mechanisms.

In one embodiment, the hollow chamber 108 is configured to hold at least one absorbent material 128 for absorbing oxygen from a headspace of the container 102. The hollow chamber 108 is adapted to expose the absorbent material 128 to the headspace of the container 102 for absorbing oxygen. The lid 110 is coupled to the hollow chamber 108. The lid 110 includes a one-way valve 114 that is configured to permit internal air present in the headspace of the container 102 to exit the container 102 while preventing ingress of external air.

In one embodiment, the one-way valve 114 comprises a sealing unit (not shown). The sealing unit is configured with an integrated locking unit that prevents accidental or unintended release of oxidizing gas into the container 102. The locking unit ensures that gas flow occurs only when a predetermined pressure threshold or user-initiated actuation is detected, thereby maintaining controlled internal conditions.

In some embodiments, the sealing unit may include a spring-biased flap, diaphragm, or elastomeric membrane that forms an airtight seal against backflow. In some embodiments, the locking unit may also incorporate a mechanical latch, a pressure-sensitive interlock, or a sensor-based verification mechanism to prevent operational faults during system handling, transportation, or maintenance. These enhanced safety features reduce the risk of contamination, over-pressurization, and premature oxidation reactions within the container 102, thereby improving system reliability and operational safety.

In one embodiment, the hollow chamber 108 comprises at least one of a mesh, perforated casing, and semi-porous polymer shell that is configured to expose the absorbent material 128 for absorbing oxygen from the headspace of the container 102. The lid 110 is configured to provide access to the hollow chamber 108 for insertion of the absorbent material 128 inside the closure unit 104. The absorbent material 128 is a de-oxygenation agent or an oxygen scavenging agent. The absorbent material 128 includes at least one of a metal-based compound, a ferrous-based scavenger, and a non-ferrous absorbent material.

The sealing member 112 is disposed circumferentially extended around an outer surface of the hollow chamber 108. The sealing member 112 is configured to form an airtight connection with the open end of the container 102 during an operation. The sealing member 112 comprises at least one of a silicone, and elastomeric material configured to deform and conform to differently sized open ends of the container 102.

In one embodiment, the backfill unit 106 is configured to be attached to the one-way valve 114 of the lid 110. The backfill unit 106 is configured to evacuate the internal air present in the headspace of the container 102 through the one-way valve 114 of the lid 110 located on the container 102. The backfill unit 106 is configured to create a vacuum-conditioned environment in the headspace of the container 102. The backfill unit 106 comprises a body 116, a vacuum pump 118, and a gas reservoir 120.

In one embodiment, the body 116 having an inlet 116A that is configured for attachment to the one-way valve 114, and an outlet 116B that is configured for releasing the internal air present in the headspace of the container 102. The vacuum pump 118 could be secured within the body 116 and coupled to the inlet 116A. The vacuum pump 118 is configured to remove at least a portion of the internal air from within the container 102, thereby reducing internal pressure in the headspace of the container 102. The air comprises, primarily containing oxygen and nitrogen. The internal air may additionally include other oxygen-containing gases.

In one embodiment, the gas reservoir 120 is disposed within the body 116. The gas reservoir 120 is configured to contain one or more inert gases. The inert gases are released into the container 102 through the inlet 116A following at least partial extraction of the internal air, thereby forming a protective barrier against oxidation within the container 102. The released inert gases after the partial extraction of the internal air and the absorbent material 128 exposed in the headspace collectively establish the protective barrier against oxidation within the container 102. The inert gases include at least one or a mixture of gases that are heavier than oxygen, which include at least one of, but not limited to, argon gas, krypton gas, xenon gas, and carbon dioxide gas.

In some embodiments, the gas reservoir 120 may include a pressurized gas cartridge, which is activated when the vacuum is created, thus minimizing the need for a separate power source during certain operations.

In one embodiment herein, the inlet 116A of the backfill unit 106 maintains the one-way valve 114 open during the vacuum phase, and once the desired vacuum pressure is achieved, the backfill unit 106 then releases the appropriate amount of inert gas (e.g. argon) into the container 102 through the one-way valve 114. After releasing the inert gas, the backfill unit 106 disengages, allowing the one-way valve 114 to close automatically due to the pressure differential between the container 102 and the surrounding environment. The lid 110 remains securely attached, and the sealing member 112 maintains an airtight seal during the entire process.

In one embodiment, the backfill unit 106 comprises a power source 122 that is configured to operate the vacuum pump 118. The backfill unit 106 comprises a user interface 124 that includes an on/off switch 124A and at least one indicator 124B for vacuum level or gas dispensing status. The on/off switch 124A is configured for activating or deactivating the vacuum pump 118.

In one embodiment, the power source 122 is an integrated or detachable electrical energy supply configured to operate the vacuum pump 118 and associated control circuitry of the backfill unit 106. In some embodiments, the power source 122 may include, but is not limited to, a rechargeable battery pack, a removable dry-cell battery, or an external power input port configured for connection to an alternating-current (AC) adapter or a universal serial bus (USB) power supply. In some embodiments, the power source 122 comprises a lithium-ion (Li-ion) or lithium-polymer (Li-Po) battery. The power source 122 may be embedded within the body 116 or housed in a sealed compartment accessible through a removable cover to facilitate battery replacement or maintenance.

In one embodiment, the body 116 defines an internal channel or compartment that is structurally configured to accommodate and secure the vacuum pump 118, the gas reservoir 120, the power source 122, and a controller 126. The controller 126 may be configured to regulate and coordinate the operations of the vacuum pump 118 and the user interface 124 associated with the gas reservoir 120, including controlling timing sequences, pressure thresholds, and safety limits. The internal channel of the body 116 may include fastening features, such as brackets, clamps, or molded seats, to ensure stable placement and vibration damping of the components during operation. The backfill unit 106 is automatically controlled by the controller 126 to regulate vacuum pressure and gas-release timing.

In another embodiment, the controller 126 is configured to regulate at least one of a vacuum-creation duration, a target negative pressure level, or a gas-release timing sequence.

In another embodiment, the controller 126 further comprises a charging circuit and a power-management module that is configured to regulate energy flow, prevent over-charging or deep discharge, and provide low-battery indication through the user interface 124. The charging circuit may employ a Type-C USB port, magnetic charging connector, or inductive charging pad to enable safe recharging. In some embodiments, the controller 126 may be supplemented or replaced by an external power interface that allows continuous operation.

In another embodiment, the indicator 124B includes at least one of a display with an oxygen sensor, and an oxygen indicator dye to measure oxygen levels present within the headspace of the container 102. The indicator 124B is configured to detect the presence of oxygen up to 0.01%.

In some embodiments, the indicator 124B may include visual, auditory, or digital output, such as LED lights, an LCD screen, and a sound alert to guide the user throughout the vacuuming and gas-dispensing process.

In one embodiment, the absorbent material 128 is positioned within the hollow chamber 108 of the closure unit 104. Following placement, the internal air is evacuated from the container 102 to establish a partial vacuum. Creating this partial vacuum decreases the volume of oxygen present, thereby reducing both the amount of the absorbent material 128 required and the time needed to remove residual oxygen from within the container 102.

In one example embodiment herein, the backfill unit 106 functions as a combined gas dispensing and vacuum system. The inlet 116A serves both to discharge the internal air from the container 102 via the one-way valve 114 and keeps the one-way valve 114 open while the container 102 reaches the desired vacuum pressure. Once the vacuum is achieved, the backfill unit 106 then releases a specified amount of argon gas into the container 102. After the desired amount of argon gas is dispensed, the inlet 116A allows the one-way valve 114 to close automatically, driven by the pressure differential between the container 102 and the surrounding environment.

During oxygen evacuation, the vacuum pressure forces the lid 110 and the seal member 112 tightly together with the container 102, thereby ensuring a secure, airtight seal. The lid 110 remains securely attached and does not need to be removed, nor does it interfere with a first end 108A of the hollow chamber 108. Due to the pressure differential between the argon gas and the partial vacuum inside the container 102, the argon gas is drawn into the container 102. As the argon gas expands when entering the vacuum, the quantity of argon gas required is reduced.

In one embodiment, the lid 110 is hingedly connected to the first end 108A of the hollow chamber 108. The hinged connection allows the lid 110 to pivot between an open position, providing access to the interior of the hollow chamber 108, and a closed position, in which the lid 110 aligns with and seals against the hollow chamber 108. The hinge may be implemented as a mechanical pin hinge, a torsion-spring hinge, or an integrated flexure hinge molded as part of the closure unit 104, thereby ensuring controlled rotational movement and maintaining consistent sealing pressure when the lid 110 is closed. The hinged arrangement simplifies user operation while ensuring reliable engagement between the lid 110, the seal member 112, and the hollow chamber 108.

In another embodiment, the sealing member 112 is hingedly connected to the first end 108A of the hollow chamber 108. The hinged connection enables the sealing member 112 to pivot between an open position, allowing access to the interior of the hollow chamber 108, and a closed position in which the sealing member 112 is seated against the hollow chamber 108 to form an airtight interface. The hinge may be implemented using a mechanical pin hinge, a molded flexure hinge, or a spring-biased hinge configured to apply consistent compressive force against the mating surfaces when closed. This arrangement ensures reliable sealing performance, minimizes user effort during operation, and maintains proper alignment between the sealing member 112 and the hollow chamber 108.

In various optional embodiments, the sealing member 112 may further include a latch mechanism configured to secure the sealing member 112 in the closed position and maintain a consistent sealing force. Exemplary latch configurations include pair of magnetic latches, a snap-fit latch, rotary cam latch, over-center toggle latch, spring-loaded hook latch, and electromagnetic latch.

The container 102 remains in a partially evacuated state, ensuring that the closure unit 104 forms an airtight seal with a neck of the container 102, thereby preventing ingress of external oxygen. Further, the absorbent material 128 positioned within the hollow chamber 108 of the closure unit 104 is configured for absorbing oxygen from the headspace of the container 102.

In one embodiment, to operate the backfill unit 106, the closure unit 104 is first attached or inserted into the open end of the container 102 using the sealing member 112 to establish an airtight connection that prevents leakage during vacuum formation. Upon activation via the user interface 124, the vacuum pump 118 removes the internal air (including oxygen and nitrogen), thereby reducing the pressure within the container 102. Once sufficient air has been extracted, the backfill unit 106 dispenses the argon gas into the container 102, allowing the heavier argon to settle in the headspace and displace any remaining oxygen. The backfill unit 106 is then removed, and the container 102 is sealed. The absorbent material 128, inside the hollow chamber 108, to absorb any trace oxygen molecules still present, while simultaneously preventing re-entry of the air into the container 102.

In some embodiments, the power source 122 supplies regulated electrical power to the vacuum pump 118 through the controller 126, which governs the duty cycle and speed of the vacuum pump 118 according to feedback from pressure or oxygen sensors. The controller 126 can also manage the timing of inert-gas release from the gas reservoir 120 to coordinate sequential vacuuming and gas-dispensing operations. Upon activation via the on/off switch 124A on the user interface 124, the power source 122 energizes the vacuum pump 118 and enables operation of the indicator 124B, which provides real-time feedback on vacuum level, gas-dispensing status, or battery charge condition.

In some embodiments, the closure unit 104 is made of a material that includes at least one of, but not limited to, plastic, silicone rubber, metal, natural cork, and synthetic cork. Further, the closure unit 104 is made of plastic that includes at least one of polyethylene terephthalate (PET), high-density polyethylene (HDPE), thermoplastic elastomer (TPE), polypropylene (PP), ethylene vinyl alcohol copolymer (EVOH), and polyamide (PA).

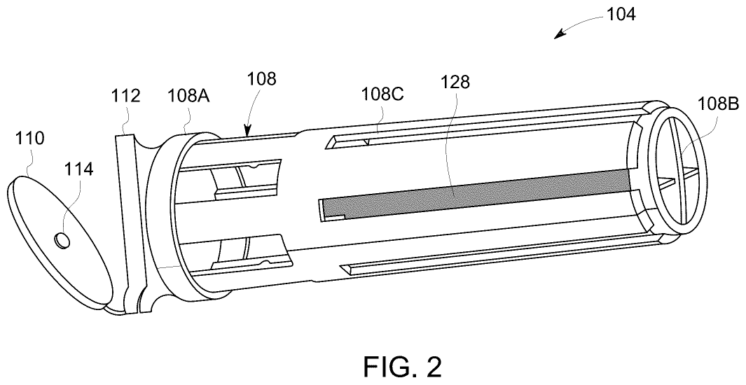

FIG. 2 illustrates a perspective view of the closure unit 104. In one embodiment herein, the closure unit 104 ensures the airtight seal when disposed on the container 102 to preserve liquids and other items, which degrade when exposed to oxygen for a period of time through the protective barrier and the absorbent material 128 against oxidation. In one embodiment herein, the closure unit 104 could be used multiple times by replacing the absorbent material 128 with new one after each use.

In another embodiment, the friction fit is a type of fastening assembly that relies on the friction between two surfaces to hold them together. In the case of the closure unit 104, the friction fit could be created between the sealing member 112 and the inside of the open end of the container 102.

In another embodiment, the snap-fit is a type of fastening assembly that uses a series of snaps to hold two surfaces together. In the case of the closure unit 104, the snap-fit could be created between the sealing member 112 and the open end of the container 102. The snap-fit could be used to couple the closure unit 104 to the open end of a reusable food storage container.

In another embodiment, the screw fit is a type of fastening assembly that uses a screw to hold two surfaces together. In the case of the closure unit 104, the screw fit could be created between the sealing member 112 and the open end of the container 102. In some embodiments, the fastening assembly include a bayonet fit, a push-fit, and a magnetic fit.

In one embodiment, the hollow chamber 108 defines a channel that is configured to store the absorbent material 128. The hollow chamber 108 includes a sidewall 108C extending between the first end 108A and a second end 108B. The hollow chamber 108 is configured to store the absorbent material 128. In another embodiment, the hollow chamber 108 comprises a substantially cylindrical or frustoconical sidewall 108C extending between the first end 108A and the second end 108B, thereby forming a cork-or stopper-shaped closure unit.

In one embodiment, the lid 110 is coupled to the first end 108A of the closure unit 104, as shown in FIG. 2. The lid 110 is openable to permit replacement of the absorbent material 128 housed within the hollow chamber 108. The lid 110 is secured to the first end 108A by a coupling arrangement that includes at least one of a friction fit, a snap fit, a screw fit, or a pivotal fit.

The sidewall 108C is formed as at least one of a mesh, perforated, or semi-porous structure, configured to allow the internal air to exit from the hollow chamber 108 while exposing the absorbent material 128 for absorbing oxygen from the headspace of the container 102.

In one embodiment, the absorbent material 128 is either a de-oxygenation agent or an oxygen scavenging agent. The absorbent material 128 that includes at least one of metal-based substance, a ferrous-based scavenger, and a non-ferrous absorbent material. The absorbent material 128 is stored in the hollow chamber 108 in a form that includes a sachet, a filament, and a granular agent. In specific, the absorbent material 128 is packed inside a gas permeable and waterproof package.

In another embodiment, the absorbent material 128 can be used to remove oxygen from the headspace of the container 102 through a chemical reaction. Metal-based absorbers, such as iron powder and sodium chloride, remove oxygen by reacting with the oxygen to form metal oxides. Other metal absorbers include elemental iron, iron oxide, iron hydroxide, iron carbide, nickel, tin, copper, and zinc. Metal absorbers are typically in the form of a powder to increase surface area. Other suitable absorbent materials include ascorbic acid, sodium ascorbate, catechol, phenol, activated carbon, polymeric materials incorporating a resin and a catalyst, ferrous carbonate, sodium hydrogen carbonate, and citrus or citric acid.

The sealing member 112 is configured to create an airtight seal for an open end of the container 102 upon insertion of the closure unit 104 through the open end. In one embodiment, the sealing member 112 is a gasket made of a material that includes at least one of plastic, silicone rubber, and any flexible polymers. The sealing member 112 comprises protrusions (not shown) that are extended outward radially from a surface of the sealing member 112. The protrusions are engaged with an interior surface of the container 102 to ensure the airtight seal for the open end of the container 102.

In another embodiment, the sealing member 112 could have a series of snaps that would fit into corresponding grooves on the open end of the container 102. In another embodiment, the sealing member 112 would have a threaded screw that would screw into a threaded hole in the open end of a wine bottle.

In some embodiments, the sealing system 100 provides combined protection of inert gas and oxygen scavenger methods. This means that it uses both inert gas and absorbent materials to protect the wine from oxygen exposure. The sealing system 100 utilizes a less aggressive de-oxygenation agent than aggressive oxygenation agent such as ferrous/metal scavenger only, which can create a partial vacuum within the headspace when oxygen is removed. This partial vacuum can displace the volatile aromatics inside the wine or juice creating a muted profile.

In some embodiments, the sealing system 100 is specifically tailored for vessels like wine bottles. It is designed to fit snugly over the neck of the bottle and create a tight seal. This prevents oxygen from leaking into the bottle and degrading the wine. Further, the sealing system 100 is a convenient and effective way to preserve opened wine. The sealing system 100 uses a combination of inert gas and oxygen scavenger methods to protect the wine from oxygen exposure and preserve its quality and flavor.

In some embodiments, the sealing system 100 is specifically tailored for wine bottles, which extends the shelf life of an opened wine bottle. The sealing system 100 protects wine from oxygen exposure and preserves the fruitier and fresher aromas and flavors of wine.

In some embodiments, inert gas covers the exposed wine surface. This prevents oxygen from coming into contact with the wine, which causes oxidation. Inert gases such as argon are colorless, odorless, and tasteless, so they do not affect the flavor of the wine. The absorbent material removes oxygen within the headspace of the container 102. The headspace is the empty space between the wine and the sealing system 100. The absorbent material removes oxygen from the headspace of the container 102, further preventing oxidation. In case, the absorbent material is a non-ferrous absorbent material such as, but not limited to, ascorbic acid. Then, the non-ferrous absorbent material reacts with oxygen and absorbs oxygen from the container 102 to release carbon dioxide which functions as a secondary inert gas to form the protective barrier in the container 102.

In some embodiments, the sealing system 100 could assist wine distributors, wineries, and consumers reduce wine waste. Wine distributors and wineries could use the sealing system 100 to preserve opened, unfinished bottles of wine. This can aid to reduce the amount of wine wasted for wine tasting, thereby saving wine cost. Wine consumers could also benefit from the sealing system 100. The wine consumers can open multiple bottles of wine at a time or open a bottle just for a glass, knowing that the unfinished wine will stay fresh for a long time. This can aid the wine consumers to enjoy their wine more and to reduce waste.

In some embodiments, in food packaging, the sealing system 100 is used to introduce inert gas into containers holding oxygen-sensitive food items, such as fresh produce or dried goods. This helps to extend the shelf life of the food by preventing degradation caused by oxygen exposure. In pharmaceutical packaging, the sealing system 100 is employed to create an inert environment for medications that are susceptible to oxidation or degradation due to oxygen exposure. This ensures the preservation of the drug's efficacy and safety. In wine preservation, the sealing system 100 is utilized to inject inert gas into wine bottles, preventing oxidation and preserving the wine's flavor and aroma. This allows wine enthusiasts to enjoy opened bottles for extended periods. In electronic component packaging, the sealing system 100 is used to create an inert atmosphere around sensitive electronic components, protecting them from moisture and oxygen damage. This enhances the reliability and lifespan of the components.

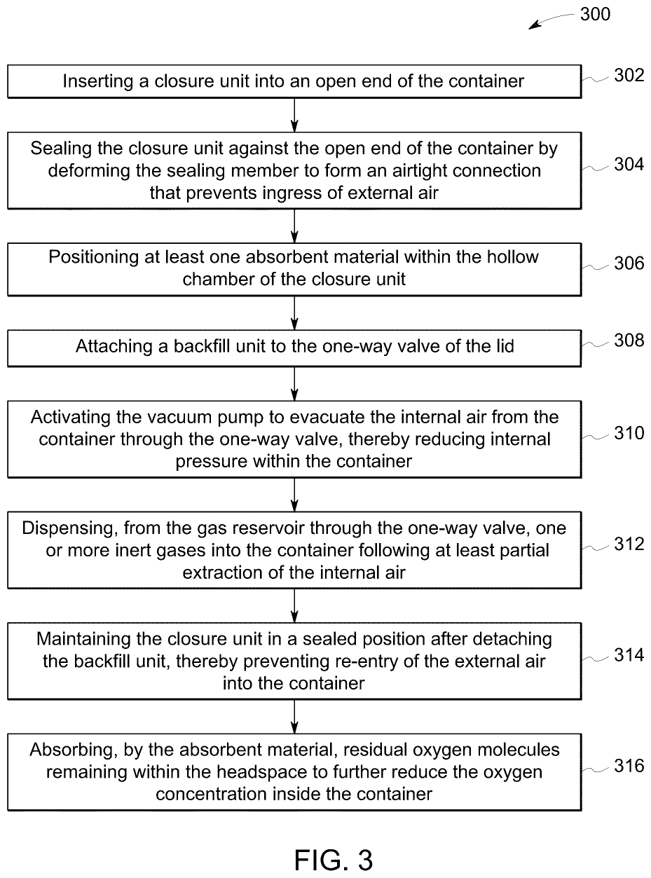

FIG. 3 illustrates a flowchart 300 of a method for reducing oxygen content within the container using the sealing system 100. At step 302, the closure unit 104 is inserted unit into the open end of the container 102. At step 304, the closure unit 104 is sealed against the open end of the container 102 by deforming the sealing member 112 to form an airtight connection that prevents ingress of the external air. At step 306, at least one absorbent material 128 is positioned within the hollow chamber 108 of the closure unit 104. The absorbent material 128 is a de-oxygenation or oxygen-scavenging agent adapted to absorb oxygen from a headspace of the container 102. Once the absorbent material 128 is properly seated within the hollow chamber 108, the lid 110 is subsequently closed to secure the closure unit 104.

At step 308, the backfill unit 106 is attached to the one-way valve 114 on the lid 110. The backfill unit 106 is automatically controlled by the controller 126 to regulate the vacuum pressure, keeping the one-way valve 114 open during the oxygen evacuation. After the vacuum pressure is achieved, the backfill unit 106 releases inert gas (e.g., argon) into the container 102. The lid 110 remains securely attached, and the sealing member 112 maintains an airtight connection throughout the process.

At step 310, the vacuum pump 118 is activated to evacuate the internal air, present in the headspace of the container 102, from the container 102 through the one-way valve 114, thereby reducing internal pressure within the container 102. At step 312, the one or more inert gases are dispensed from the gas reservoir 120 through the one-way valve 114 into the container 102 following at least partial extraction of the internal air. The inert gases form the protective barrier above the contents of the container 102 to inhibit oxidation. At step 314, the closure unit 104 is maintained in a sealed position after detaching the backfill unit 106, thereby preventing re-entry of the air into the container 102. At step 316, the absorbent material 128 absorbs the residual oxygen molecules remaining within the headspace of the container 102 to further reduce the oxygen concentration inside the container 102.

In some embodiments, the sealing system 100 is configured to operate in multiple oxygen-reduction configurations depending on a preservation requirement of a product stored within the container 102.

In some embodiments, the sealing system 100 is operable in a first configuration in which the absorbent material 128 is absent or inactive. The internal air is partially evacuated by the vacuum pump 118, followed by controlled introduction of inert gas from the gas reservoir 120 to form the protective barrier. The first configuration minimizes gas consumption while rapidly reducing oxygen concentration.

In some embodiments, the sealing system 100 is operable in a second configuration in which the vacuum pump 118 evacuates the internal air from the container 102 and the absorbent material 128 removes residual oxygen, while the gas reservoir 120 is not activated. The vacuum pump 118 creates a reduced-oxygen environment, allowing the absorbent material 128 to remove residual oxygen more rapidly. The second configuration is suitable where inert gas is unavailable or unnecessary.

In some embodiments, the sealing system 100 is operable in a third configuration in which the one or more inert gases are introduced into the container 102 and the absorbent material 128 removes residual oxygen, while the vacuum pump 118 is not activated. In applications where vacuum evacuation is undesirable (e.g., delicate beverages), inert gas displaces the internal air while the absorbent material 128 eliminates micro-oxygen that remains dissolved or trapped in the headspace of the container 102.

In some embodiments, the vacuum pump 118, the inert gas, and the absorbent material 128 operate sequentially to produce the lowest possible oxygen concentration. The vacuum stage reduces initial oxygen, the inert gas forms a physical barrier, and the absorbent material 128 eliminates trace oxygen. These oxygen-reduction configurations enable the sealing system 100 to be applied across wine, food, pharmaceuticals, chemicals, and other oxygen-sensitive products.

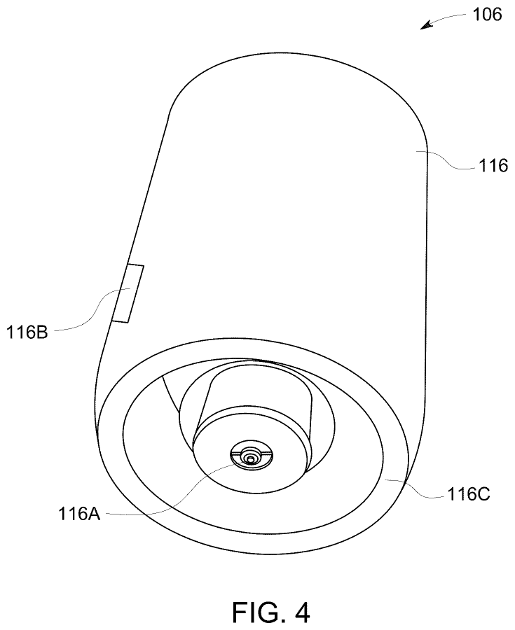

FIG. 4 illustrates a perspective view of the backfill unit 106 of the sealing system 100. The body 116 of the backfill unit 106 defines a fastening bracket 116C. The fastening bracket 116C is configured to be attached to the lid 110, thereby creating an airtight connection between the backfill unit 106 and the lid 110.

In one embodiment, the fastening bracket 116C comprises one or more snap-fit clips or locking projections that engage with corresponding recesses or retaining slots formed on the lid 110, thereby enabling tool-less attachment and detachment.

In another embodiment, the fastening bracket 116C includes at least one mechanical attachment feature such as a threaded opening configured to receive a fastening screw that secures the lid 110 to the body 116.

To ensure airtightness, the fastening bracket 116C may further include a sealing interface such as an elastomeric gasket, an O-ring, or a compressible sealing pad positioned between the fastening bracket 116C and the lid 110. When the lid 110 is secured, the sealing element is compressed to form a reliable airtight barrier.

In some embodiments, the fastening bracket 116C additionally incorporates alignment features such as guide pins, raised edges, positioning ribs, or key-and-slot structures that ensure the lid 110 seats accurately and uniformly onto the body 116 before the fastening mechanism is engaged. These combined features provide structural stability, consistent sealing performance, and repeatable attachment during assembly or maintenance of the backfill unit.

In some embodiments, the fastening bracket 116C is detachably attached to the lid 110 through a fitting mechanism that includes at least one of a friction fit, a snap fit, a screw fit, and a pivotal fit thereof. In one embodiment, the fitting mechanism is located over an inner structure of the body 116 and ensures a secure and stable attachment.

The sealing system 100 is designed for repeated and long-term use. The closure unit 104 and the backfill unit 106 are constructed from durable materials comprise, but are not limited to, silicone, thermoplastic polyurethane (TPU), and metals including aluminum or stainless steel. These materials provide structural integrity, resistance to wear, and suitability for frequent sealing and unsealing operations.

In some embodiment, the closure unit 104 comprises an indicator unit configured to provide a visual or audible notification that the container 102 is properly sealed by the closure unit 104. The indicator may illuminate, blink, change color, or emit a sound once the target vacuum level or sealing threshold is achieved.

In some embodiments, the sealing system 100 may additionally include a built-in controller configured to generate and display status information associated with the internal condition of the container 102, including but not limited to vacuum pressure, oxygen level, or other environmental parameters.

In some embodiments, the controller 126 is configured to perform the above functions in conjunction with a network, thereby enabling remote monitoring or control of the sealing system 100 through a user device. The user device represents any electronic device that the user can utilize to interact with the sealing system 100. The user device can be, but not limited to, a smartphone, a laptop, a tablet, a personal computer, or any other suitable electronic device.

In some embodiments, the network can be a wireless communication infrastructure, which offers the users flexibility and convenience when interacting with the controller 126. This wireless connectivity enables the users to access the sealing system 100 from various locations, without being tethered to a fixed physical connection. the network can be, but not limited to, Local Area Network (LAN), Cellular Network, Wide Area Network (WAN), Intranet, Virtual Private Network (VPN), Bluetooth, Wi-Fi, and wireless networks that use radio frequency (RF) or infrared (IR) technology to transmit data without the need for physical cables, thereby providing mobility and flexibility. The versatility of the network ensures that the user device can seamlessly connect to the sealing system 100 from a variety of locations and devices. This wireless connectivity enhances the overall accessibility and convenience of the sealing system 100 for the users.

In one embodiment, the closure unit 104 is further configured to accommodate a variety of container geometries and sizes, allowing the sealing system 100 to be used with different types of containers.

In another embodiment, the closure unit 104 is configured to accommodate a variety of container sizes, shapes, and materials. The closure unit 104 may include flexible sealing edges, adjustable clamping structures, or interchangeable adapters that allow the sealing system 100 to be used with different container geometries.

In another embodiment, the closure unit 104 may further incorporate features such as reinforced sealing ribs, gasket structures, or alignment guides to ensure a consistent airtight interface between the closure unit 104 and the container 102 during repeated use.

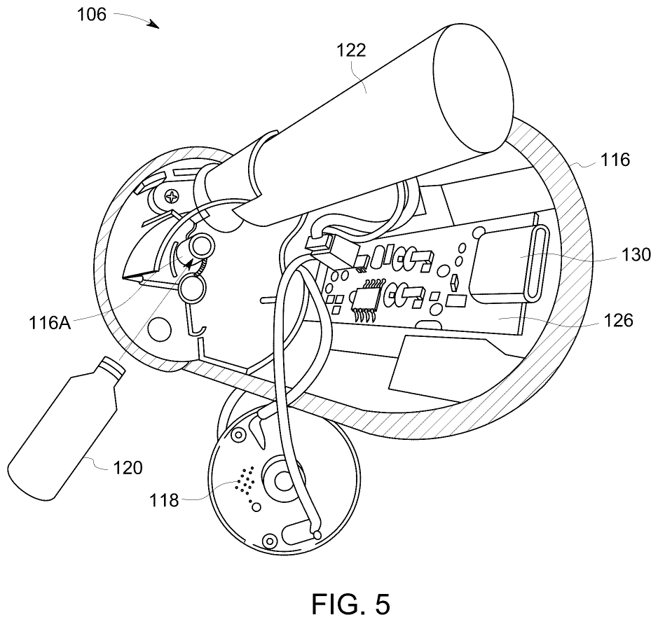

FIG. 5 illustrates an angled internal view of the backfill unit 106 of the sealing system 100. The power source 122 is an integrated or detachable electrical energy supply configured to operate the vacuum pump 118 and associated control circuitry of the backfill unit 106. In some embodiments, the power source 122 may include, but is not limited to, a rechargeable battery pack, a removable dry-cell battery, an on-board battery, or an external power input port configured for connection to an alternating-current (AC) adapter or a universal serial bus (USB) power supply.

In another embodiment herein, the vacuum pump 118 and the power source 122 are operatively connected to the controller 126 such that the controller 126 governs the activation, deactivation, and overall operation of the vacuum pump 118. In a preferred embodiment, the vacuum pump 118 and the power source 122 are electrically connected to the controller 126 through dedicated electrical pathways or control lines. This electrical connection enables the controller 126 to regulate the flow of electrical power from the power source 122 to the vacuum pump 118, thereby allowing the controller 126 to execute commands such as initiating suction cycles, adjusting pump speed or duration, and shutting off the pump based on sensor feedback, or programmed logic.

In one embodiment herein, the backfill unit 106 further comprises a USB port 130, which is configured to recharge the power source 122. The USB port 130 is electrically connected to the charging circuit or power-management module disposed on the controller 126 or on an associated printed circuit board. Through this electrical connection, external electrical energy supplied through the USB port 130 is regulated and directed to the power source 122 for controlled charging.

In some embodiments, the USB port 130 may also support dual functions such as providing diagnostic communication, firmware updates, or power-bypass operation, thereby allowing the backfill unit 106 to operate directly from an external power supply while simultaneously charging the power source 122. The inclusion of the USB port 130 thereby enables convenient recharging, enhances portability, and ensures sustained operation of the backfill unit 106 without requiring removal or replacement of the power source 122.

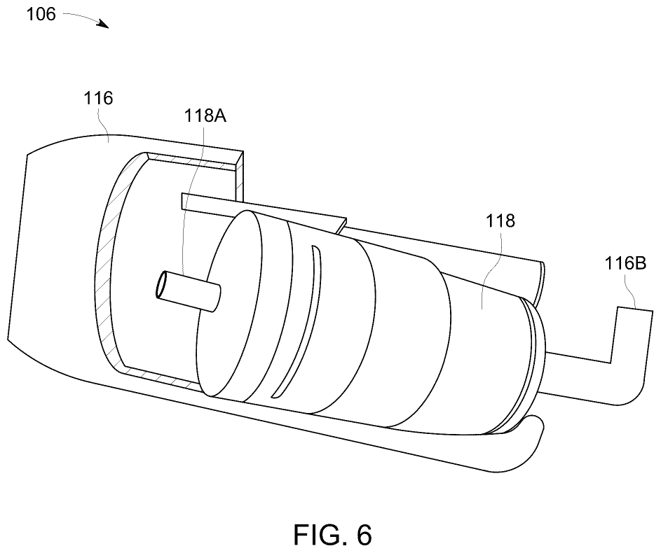

FIG. 6 illustrates a perspective view of the vacuum pump 118 of the backfill unit 106. The vacuum pump 118 comprises a suction pipe 118A. During operation, oxygen-containing air is drawn by the vacuum pump 118 through the suction pipe 118A from the container 102 via the inlet 116A to achieve a desired vacuum pressure. In a preferred embodiment, during operation, oxygen-containing air is drawn from the container 102 through the inlet 116A and into the suction pipe 118A, thereby allowing the vacuum pump 118 to generate the required vacuum pressure. The extracted gas is then discharged from the vacuum pump 118 and expelled outward through the outlet 116B. This extraction process generates a negative pressure within the space defined between the inlet 116A and the one-way valve 114 of the lid 110, thereby creating a controlled vacuum environment inside the container 102.

Once the desired vacuum pressure is achieved, inert gas is released from the gas reservoir 120. The inert gas naturally flows from the higher-pressure reservoir into the lower-pressure container 102 through the inlet 116A and the one-way valve 114 of the lid 110. The inert gas flows into the container 102 through the hollow chamber 108 of the closure unit 104 as a result of the negative pressure generated inside the container 102. In a preferred embodiment, the inert gas enters the container 102 through the sidewall 108C of the hollow chamber 108, which extends between the first end 108A and the second end 108B. This configuration facilitates a controlled and evenly distributed flow of inert gas into the interior of the container 102. This inert gas remains contained within the container 102 because the vacuum pump 118 also functions as a sealing element when it is not operating. After the required quantity of inert gas is delivered into the container 102, the one-way valve 114 closes due to the partial vacuum maintained inside the container 102 when the backfill unit 106 is removed from the closure unit 104.

In exemplary embodiments, the sealing system 100 operates through a coordinated sequence involving oxygen absorption, vacuum generation, and controlled inert-gas backfilling. The hollow chamber 108 of the closure unit 104 may include permeable wall portions such as mesh, perforations, or semi-porous polymer regions that provide uniform gaseous communication between the contents of the hollow chamber 108 and the headspace of the container 102. The absorbent material 128 disposed within the hollow chamber 108 may be selected from a wide range of oxygen-scavenging substances, including but not limited to ferrous-based scavengers (e.g., iron powder, iron oxide formulations), metal-based compounds (e.g., copper, manganese dioxide, cobalt complexes), non-ferrous absorbent materials (e.g., polymeric scavengers, enzymatic scavengers, activated carbon), and blends thereof. These materials may be provided in granular, pellet, powder, or encapsulated form to suit various oxygen-removal rates.

In some embodiment, the vacuum pump 118 of the backfill unit 106 may be configured to achieve pressure reductions across a range of vacuum levels, such as between approximately 10 kPa and 90 kPa below atmospheric pressure, depending on container size and desired oxygen reduction. In some embodiments, the backfill unit 106 withdraws air from the headspace through the one-way valve 114 of the closure unit 104 until a predetermined negative pressure value is reached. Following this extraction, the gas reservoir 120 may deliver one or more inert gases—including argon, krypton, xenon, carbon dioxide, or mixtures thereof —into the container. These gases are selected for their density and chemical inertness, thereby enabling stratification or displacement of residual oxygen within the headspace. The flow of inert gas may occur at controlled rates to ensure stable distribution of the gas within the container 102 and may be regulated by metering valves, flow restrictors, or pressure-regulated outlets integrated within the backfill unit 106.

In one embodiment, the oxygen-containing gas removed by the vacuum pump 118 is directed entirely through the outlet 116B, and therefore does not mix with the inert gas present within the sealing system 100. The oxygen-rich exhaust remains isolated from the gas reservoir 120 or inert-gas injection pathway, ensuring that the internal environment of the container 102 maintains a desired inert-gas concentration without cross-contamination.

Further, the closure unit 104 provides non-invasive double action preservation systems, which do not displace volatile aromatics of the product, for example, wine out of the container 102 and thereby preserves the product's scents, flavors, and taste.

In another embodiment, the sealing system 100 disclosed herein employs a sequential and mutually reinforcing process in which, first, controlled vacuum extraction first reduces the oxygen volume and prepares the headspace. Then, inert gas infusion immediately forms a dense protective barrier that stabilizes volatile aromatic compounds. Later, the absorbent material 128 eliminates micro-oxygen that cannot be removed through vacuum or displacement alone. The combined effect is synergistic, the vacuum stage significantly reduces the load on the absorbent material 128, the inert gas prevents negative-pressure stripping of aromatics inherent in vacuum-only systems, and the absorbent material 128 eliminates residual oxygen that inert gas alone cannot fully displace.

In another embodiment, the controller 126 is in communication with a pressure sensor positioned within the container 102. The one-way valve 114 may be implemented as either a passive check valve or an actively actuated valve. The gas reservoir 120 is fluidly connected to a proportional pressure regulator or a mass flow controller (MFC) configured to meter inert gas into the inlet 116A. During evacuation, the controller 126 maintains the one-way valve 114 in an open state to enable continuous removal of the air from the container 102 until the pressure sensor detects that the target vacuum level has been achieved. Once the target vacuum pressure is reached, the controller 126 closes or allows the one-way valve 114 to return to its sealed state and subsequently actuates the proportional pressure regulator or MFC to permit controlled admission of inert gas from the gas reservoir 120 into the container 102 via the inlet 116A through the one-way valve 114. The controller 126 terminates the flow of inert gas when a predefined fill threshold or internal pressure level is reached, thereby ensuring that the desired quantity of inert gas is delivered into the container 102.

In another embodiment, the inlet 116A and the one-way valve 114 are equipped with a solenoid actuator or an electromagnetic latch that maintains the valve in an open position during the evacuation phase. Once the target vacuum level is achieved, the controller 126 then initiates a controlled release of inert gas from the gas reservoir 120 (or opens a dedicated fill valve) until the predefined fill criteria are satisfied. After the filling process is completed, the one-way valve 114 remains securely latched in the closed state.

In some embodiments, the controller 126 is operatively connected to the vacuum pump 118 and the gas reservoir 120 to coordinate the timing, sequence, and magnitude of vacuum and gas-delivery operations. The controller 126 may include pre-programmed logic or sensor-based feedback systems, such as pressure sensors that detect the achieved vacuum level or flow sensors that monitor inert-gas dispensing rates. The controller 126 may terminate vacuum generation upon reaching a target pressure threshold and subsequently initiate gas-release cycles defined by time, pressure, or volume parameters. Additionally, the controller 126 may manage user interface elements, such as visual indicators that display real-time vacuum level or gas-dispensing status.

In another embodiment, the gas reservoir 120 is sealed with a rupturable diaphragm that is in fluid communication with the inlet 116A. The rupturable diaphragm is formed of a calibrated, frangible membrane designed to withstand normal handling pressures but to rupture at a predefined differential vacuum threshold. When the evacuation process reduces the internal pressure of the container 102 to the target vacuum level, the resulting pressure differential across the diaphragm causes the membrane to rupture in a controlled manner. Upon rupture, the inert gas stored within the gas reservoir 120 is automatically released into the inlet 116A and subsequently admitted into the container 102 without requiring active actuation.

In some embodiments, the diaphragm may be made of metal foil, polymer film, or composite laminate selected based on predictable burst characteristics and compatibility with the inert gas. The rupture pressure threshold may be factory-calibrated to ensure consistent performance across units. The passive, pressure-triggered operation of the rupturable diaphragm provides a mechanically simple and fail-safe method for delivering inert gas into the container 102.

In some embodiments, the sealing system 100 could increase wine sales for food and beverages (F&B) services in a few ways. The sealing system 100 allows restaurants to feature more wines by the glass. This is because customers are more likely to order a glass of wine if they know that the unfinished bottle can be preserved for later consumption. This allows restaurants to offer a wider variety of wines to their customers, which can lead to increased sales. Further, the sealing system 100 could encourage customers to order multiple bottles of wine. This is because customers could finish the bottles at their own pace, without having to worry about the wine going bad. This can lead to increased sales for restaurants, especially for high-end wines. The sealing system 100 could improve the customer experience. Customers appreciate the ability to enjoy the same bottle of wine over multiple visits. This can lead to increased customer satisfaction and loyalty.

In some embodiments, the sealing system 100 is a cost-effective way for wine educators, sommeliers, and wine students to re-taste opened wines or conduct multiple blind tasting exercises by saving or sharing unfinished bottles.

In some embodiments, the sealing system 100 could assist wine distributors, wineries, and consumers reduce wine waste. Wine distributors and wineries could use the sealing system 100 to preserve opened, unfinished bottles of wine. This can aid to reduce the amount of wine wasted for wine tasting, thereby saving wine cost. Wine consumers could also benefit from the sealing system 100. The wine consumers can open multiple bottles of wine at a time or open a bottle just for a glass, knowing that the unfinished wine will stay fresh for a long time. This can aid the wine consumers to enjoy their wine more and to reduce waste.

In some embodiments, in food packaging, the sealing system 100 is used to introduce inert gas into containers holding oxygen-sensitive food items, such as fresh produce or dried goods. This helps to extend the shelf life of the food by preventing degradation caused by oxygen exposure. In pharmaceutical packaging, the sealing system 100 is employed to create an inert environment for medications that are susceptible to oxidation or degradation due to oxygen exposure. This ensures the preservation of the drug's efficacy and safety. In wine preservation, the sealing system 100 is utilized to inject inert gas into wine bottles, preventing oxidation and preserving the wine's flavor and aroma. This allows wine enthusiasts to enjoy opened bottles for extended periods. In electronic component packaging, the sealing system 100 is used to create an inert atmosphere around sensitive electronic components, protecting them from moisture and oxygen damage. This enhances the reliability and lifespan of the components.

In some embodiment, the sealing system 100 is configured to introduce the inert gas into containers that houses oxygen-sensitive food items, including but not limited to fresh produce and dried goods. In some embodiments, the sealing system 100 is operable for use in the absence of the absorbent material 128.

In some embodiment, the sealing member 112 positioned around the hollow chamber 108 may be formed from deformable materials such as silicone, rubber, or elastomeric polymers that allow the closure unit 104 to adapt to a range of container openings while maintaining an airtight seal. The removable attachment of the closure unit 104 to the container 102 may be achieved through friction-fit geometries, snap-fit mechanisms, threaded couplings, or rotational engagement structures such as bayonet-type locking interfaces. The structural and operational features described herein collectively enable the sealing system 100 to reliably reduce oxygen concentration within the container by combining oxygen-absorption chemistry, vacuum-based air removal, and controlled inert-gas displacement.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A sealing system for reducing oxygen content within a container, comprising:
a closure unit adapted to be inserted into an open end of the container, wherein the closure unit comprises:
a hollow chamber configured to hold at least one absorbent material, wherein the hollow chamber is adapted to expose the at least one absorbent material to a headspace of the container for absorbing oxygen;
a lid coupled to the hollow chamber, wherein the lid includes a one-way valve configured to permit air from the headspace to exit the container while preventing ingress of external air; and
a sealing member disposed circumferentially extended around an outer surface of the hollow chamber, wherein the sealing member is configured to form an airtight connection with the open end of the container during operation; and
a backfill unit configured to be attached to the one-way valve of the lid, wherein the backfill unit comprises:
a body having an inlet configured for attachment to the one-way valve, and an outlet configured for releasing extracted air;
a vacuum pump secured within the body and coupled to the inlet, wherein the vacuum pump is configured to remove at least a portion of air present in the headspace of the container, thereby reducing internal pressure within the container; and
a gas reservoir disposed within the body, wherein the gas reservoir is configured to contain one or more inert gases, wherein the one or more inert gases are released into the container through the inlet following at least partial extraction of the air present in the headspace, thereby forming an inert-gas-enriched environment that inhibits oxidation of contents within the container.

2. The sealing system of claim 1, wherein the hollow chamber comprises at least one of a mesh, perforated casing, and semi-porous polymer shell that is configured to expose the at least one absorbent material for absorbing oxygen from the headspace of the container.

3. The sealing system of claim 1, wherein the lid is configured to provide access to the hollow chamber for insertion of the at least one absorbent material inside the closure unit.

4. The sealing system of claim 1, wherein the sealing member comprises at least one of a silicone, and elastomeric material that is configured to deform and conform to differently sized open ends of the container.

5. The sealing system of claim 1, wherein the at least one absorbent material comprises a de-oxygenation agent or an oxygen scavenging agent, wherein the at least one absorbent material includes at least one of a metal-based compound, a ferrous-based scavenger and a non-ferrous absorbent material.

6. The sealing system of claim 1, wherein the backfill unit is automatically controlled by a controller to regulate vacuum pressure and gas-release timing.

7. The sealing system of claim 1, wherein the closure unit is removably coupled to the open end of the container through at least one of a friction fit, a snap fit, a rotatable fit, and a screw fit.

8. The sealing system of claim 1, wherein the backfill unit comprises a power source that is configured to operate the vacuum pump.

9. The sealing system of claim 1, wherein the backfill unit comprises a user interface that includes an on/off switch and at least one indicator for vacuum level or gas dispensing status.

10. The sealing system of claim 1, wherein the one or more inert gases include at least one or a mixture of gases that are heavier than oxygen, which include at least one of argon gas, krypton gas, xenon gas, and carbon dioxide gas.

11. A sealing system for reducing oxygen content within a container, comprising:
a closure unit adapted to be inserted into an open end of the container, wherein the closure unit comprises:
a hollow chamber configured to store at least one absorbent material, wherein the at least one absorbent material is configured for absorbing oxygen from a headspace of the container;
a one-way valve integrated into a lid of the closure unit, wherein the one-way valve is configured to permit oxygen to exit the container while preventing ingress of external air; and
a sealing member disposed circumferentially extended around an outer surface of the hollow chamber, wherein the sealing member is configured to form an airtight connection with the open end of the container during operation,
wherein the sealing member and the lid are tightly secured to the container due to the vacuum pressure, thereby ensuring that oxygen is evacuated without disturbing the sealing member; and
a backfill unit configured to be attached to the one-way valve of the lid, wherein the backfill unit is configured to create a vacuum-conditioned environment in the headspace of the container, wherein the backfill unit comprises:
a body having an inlet attached to the one-way valve, and an outlet for releasing the oxygen from the one-way valve of the lid;
a vacuum pump secured within the body, and fixed to the inlet, wherein the vacuum pump is configured to remove at least a portion of the oxygen from within the container through the one-way valve via the outlet; and
a gas reservoir disposed within the body, wherein the gas reservoir is configured to contain argon gas, wherein the argon gas is released into the container through the inlet following at least partial extraction of the oxygen to form a protective barrier against oxidation within the container.

12. The sealing system of claim 11, wherein the lid is configured to provide access to the hollow chamber for insertion of the at least one absorbent material inside the closure unit.

13. The sealing system of claim 11, wherein the backfill unit comprises a power source that is configured to operate the vacuum pump.

14. The sealing system of claim 11, wherein the backfill unit comprises a user interface that includes an on/off switch and at least one indicator for vacuum level or gas dispensing status.

15. The sealing system of claim 11, wherein the sealing member comprises at least one of a silicone, and elastomeric material that is configured to deform and conform to differently sized open ends of the container.

16. The sealing system of claim 11, wherein the hollow chamber comprises at least one of a mesh, perforated casing, and semi-porous polymer shell that is configured to expose the at least one absorbent material for absorbing oxygen from the headspace of the container.

17. The sealing system of claim 11, wherein the at least one absorbent material is a de-oxygenation agent or an oxygen scavenging agent, wherein the at least one absorbent material includes at least one of a metal-based compound and a ferrous-based scavenger.

18. The sealing system of claim 11, wherein the backfill unit is automatically controlled by a controller to regulate vacuum pressure and gas-release timing.

19. The sealing system of claim 11, wherein the closure unit is removably coupled to the open end of the container through at least one of a friction fit, a snap fit, a rotatable fit, and a screw fit.

20. A method for reducing oxygen content within a container using a sealing system, comprising:
inserting a closure unit into an open end of the container, wherein the closure unit comprises a hollow chamber, a lid with a one-way valve, and a sealing member circumferentially disposed around an outer surface of the hollow chamber;
sealing the closure unit against the open end of the container by deforming the sealing member to form an airtight connection that prevents ingress of external air;
positioning at least one absorbent material within the hollow chamber of the closure unit, wherein the absorbent material is a de-oxygenation or oxygen-scavenging agent adapted to absorb oxygen from a headspace of the container;
attaching a backfill unit to the one-way valve of the lid, wherein the backfill unit is automatically controlled by a controller to regulate vacuum pressure by the controller to regulate the vacuum pressure;
activating the vacuum pump to evacuate internal air from the container through the one-way valve, thereby reducing internal pressure within the container;
dispensing, from the gas reservoir through the one-way valve, one or more inert gases into the container following at least partial extraction of the internal air, wherein the inert gases form a protective barrier above the contents of the container to inhibit oxidation;
maintaining the closure unit in a sealed position after detaching the backfill unit, thereby preventing re-entry of the external air into the container; and
absorbing, by the absorbent material, residual oxygen molecules remaining within the headspace to further reduce the oxygen concentration inside the container.
